(19) United States
(12) Patent Application Publication
(10) Pub. No.: US 2019/0036167 A1
(43) Pub. Date: Jan. 31, 2019

(54) ELECTROLYTE COMPOSITION, SECONDARY BATTERY, AND METHOD FOR USING SECONDARY BATTERY

(71) Applicants: LINTEC Corporation, Tokyo (JP); SOPHIA School Corporation, Tokyo (JP)

(72) Inventors: Seitaro YAMAGUCHI, Tokyo (JP); Sou MIYATA, Tokyo (JP); Masahiro FUJITA, Tokyo (JP); Masahiro RIKUKAWA, Tokyo (JP)

(73) Assignees: LINTEC Corporation, Tokyo (JP); SOPHIA School Corporation, Tokyo (JP)

(21) Appl. No.: 15/755,902

(22) PCT Filed: Aug. 30, 2016
(86) PCT No.: PCT/JP2016/075274

§ 371 Date: Feb. 27, 2018

(30) Foreign Application Priority Data
Aug. 31, 2015 (JP) 2015-170273

(51) Int. Cl. H01M 10/0567; H01M 10/0525

(52) U.S. Cl. CPC H01M 10/0567; H01M 2300/0025; H01M 10/0525

(57) ABSTRACT

The invention is an electrolyte composition comprising the following component (A), component (B) and component (C):
component (A): an ionic compound having a melting point of 200° C. or lower (except for the following components (B) and (C)),
component (B): an ionic compound including a Group 1 or 2 metal ion in the periodic table, and
component (C): a zwitterionic compound, and
a secondary battery having a positive electrode, a negative electrode, and the electrolyte composition, and
a method for using the secondary battery, wherein an upper limit of a cutoff voltage during charging is 4.4 to 5.5 V.

One aspect of the invention provides an electrolyte composition excellent in flame retardance and non-volatility, a secondary battery excellent in cycling characteristics and having a high capacity, and a method for using the secondary battery.

### TECHNICAL FIELD

The present invention relates to an electrolyte composition excellent in flame retardance and non-volatility, a secondary battery excellent in cycling characteristics and having a high capacity, and a method for using the secondary battery.

### BACKGROUND ART

In recent years, ionic liquids (ionic compounds which have low melting points and exist as liquids even at around room temperature) have attracted attention as electrolytic components and the like because of excellent flame retardance, non-volatility and the like.

For example, Patent Literature 1 describes an ionic liquid having a cyanomethanesulfonate anion, an electrolyte including the ionic liquid, a lithium secondary battery including the electrolyte, and the like.

However, in a secondary battery using an electrolyte including an ionic liquid, its discharge capacity sometimes suddenly dropped when charge and discharge were repeated with a high upper limit of a cutoff voltage during charging. Thus, the upper limit of the cutoff voltage during charging had to be lowered to prevent the discharge capacity from dropping even when repeating charge and discharge, and it could not be used as a high capacity battery.

### CITATION LIST

### Patent Literature

Patent Literature 1: JP-A-2013-139425

### SUMMARY OF INVENTION

### Technical Problem

The present invention has been made under such circumstances, and has an object to provide an electrolyte composition excellent in flame retardance and non-volatility, a secondary battery excellent in cycling characteristics (meaning that the discharge capacity rarely drops even when repeating charge and discharge) and having a high capacity, and a method for using the secondary battery.

### Solution to Problem

As a result of intensive studies in order to solve the above problems, the present inventors have found that i) an electrolyte composition containing (A) an ionic compound having a melting point of 200° C. or lower, (B) an ionic compound including a Group 1 or 2 metal ion in the periodic table, and (C) a zwitterionic compound is excellent in flame retardance and non-volatility, and that ii) a secondary battery excellent in cycling characteristics and having a high capacity could be obtained by using this electrolyte composition, and have completed the present invention.

Thus, one aspect of the invention provides electrolyte compositions of (1) to (7), a secondary battery of (8), and a method for using a secondary battery of (9), described below.

(1) An electrolyte composition containing the following component (A), component (B) and component (C):

component (A): an ionic compound having a melting point of 200° C. or lower (except for the following components (B) and (C)),

component (B): an ionic compound including a Group 1 or 2 metal ion in the periodic table, and

component (C): a zwitterionic compound.

(2) The electrolyte composition according to (1), wherein the component (A) is a compound including a pyrrolidinium cation.
(3) The electrolyte composition according to (1) or (2), wherein the component (A) is a compound including a sulfonylamide anion having a fluorine atom.
(4) The electrolyte composition according to any of (1) to (3), wherein the component (B) is a compound including a lithium ion.
(5) The electrolyte composition according to any of (1) to (4), wherein the component (C) is a compound represented by the following formula (III):

Y⁺—Z—SO₃⁻ (III)

(wherein Y⁺ represents a cationic group including one or plural nitrogen atoms or phosphorus atoms and having one bonding hand, and Z represents an alkylene group having 2 to 5 carbon atoms which binds to the nitrogen atom or the phosphorus atom in Y⁺.)
(6) The electrolyte composition according to any of (1) to (5), wherein a content of the component (B) is 1 to 60 mass % based on a total amount of the component (A), the component (B) and the component (C).
(7) The electrolyte composition according to any of (1) to (6), wherein a content of the component (C) is 0.1 to 20 mass % based on the total amount of the component (A), the component (B) and the component (C).
(8) A secondary battery having a positive electrode, a negative electrode, and the electrolyte composition according to any of (1) to (7).
(9) A method for using the secondary battery according to (8), wherein an upper limit of a cutoff voltage during charging is 4.4 to 5.5 V.

### Advantageous Effects of Invention

One aspect of the invention provides an electrolyte composition excellent in flame retardance and non-volatility, a secondary battery excellent in cycling characteristics and having a high capacity, and a method for using the secondary battery.

### BRIEF DESCRIPTION OF DRAWINGS

FIG. 1 illustrates graphs showing the results of a constant current charge/discharge test (1) carried out in Examples.

FIG. 2 illustrates graphs showing the results of a constant current charge/discharge test (2) carried out in Examples.

### DESCRIPTION OF EMBODIMENTS

Hereinafter, the embodiments of the present invention will be classified into 1) the electrolyte composition and 2) the secondary battery and the method for using the second battery, and described in detail.

### 1) Electrolyte Composition

The electrolyte composition according to one embodiment of the invention contains the following component (A), component (B) and component (C):

component (A): an ionic compound having a melting point of 200° C. or lower (except for the following components (B) and (C)),

component (B): an ionic compound containing a Group 1 or 2 metal ion in the periodic table, and

component (C): a zwitterionic compound.

### [Component (A)]

The component (A) constituting the electrolyte composition according to one embodiment of the invention is an ionic compound having a melting point of 200° C. or lower (except for the components (B) and (C)).

Since the electrolyte composition of the present invention contains the component (A), it is excellent in flame retardance and non-volatility.

The melting point of the component (A) is 200° C. or lower, preferably 180° C. or lower, and more preferably 150° C. or lower.

When the melting point of the component (A) is 200° C. or lower, a high ion conductivity can be maintained.

In addition, the melting point of the component (A) is preferably −150° C. or higher, and more preferably −100° C. or higher.

The melting point of the component (A) is preferably in a range of −150 to +200° C., more preferably −100 to +180° C., and even more preferably −100 to +150° C.

A combination of a cation and an anion constituting the component (A) is not particularly limited as long as an ionic compound having a melting point of 200° C. or lower can be obtained.

Examples of the cation constituting the component (A) include e.g. cations represented by the following formulas (I) and (II).

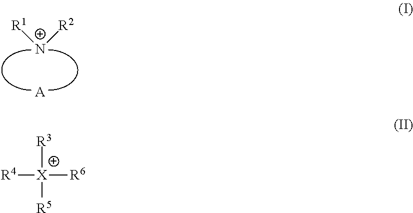

In the formula (I), each of R¹ and R² independently represents a hydrogen atom, or a hydrocarbon group having 1 to 20 carbon atoms unsubstituted or having substituents. However, when a nitrogen atom in the formula (I) is one of atoms constituting the double bond, R² is absent.

A represents a group including two bonding hands having 4 to 20 carbon atoms.

In the formula (II), each of R³ to R⁶ independently represents a hydrogen atom, or a hydrocarbon group having 1 to 20 carbon atoms unsubstituted or having substituents. X represents a nitrogen atom, a phosphorus atom or a sulfur atom. However, when X is sulfur atom, R⁶ is absent.

In the R¹ to R⁶, the number of carbon atoms in the hydrocarbon group unsubstituted or having substituents is 1 to 20, preferably 1 to 10, and more preferably 1 to 5. In this case, when the hydrocarbon group has a substituent including carbon atoms, the number of carbon atoms in the hydrocarbon group does not include the number of carbon atoms in the substituent.

Examples of the hydrocarbon group having 1 to 20 carbon atoms in the R¹ to R⁶ include an alkyl group having 1 to 20 carbon atoms such as a methyl group, an ethyl group, an n-propyl group, an isopropyl group, an n-butyl group, an s-butyl group, an isobutyl group, a t-butyl group, an n-pentyl group, an n-hexyl group, an n-heptyl group, an n-octyl group, an n-nonyl group and an n-decyl group; an alkenyl group having 2 to 20 carbon atoms such as a vinyl group, a 1-propenyl group, a 2-propenyl group, an isopropenyl group, a 3-butenyl group, a 4-pentenyl group and a 5-hexenyl group; an alkynyl group having 2 to 20 carbon atoms such as an ethynyl group, a propargyl group and a butynyl group; a cycloalkyl group having 3 to 20 carbon atoms such as a cyclopropyl group, a cyclopentyl group and a cyclohexyl group; an aryl group having 6 to 20 carbon atoms such as a phenyl group, a 1-naphthyl group and a 2-naphthyl group; and the like.

Examples of the substituent included in the alkyl groups having 1 to 20 carbon atoms, the alkenyl group having 2 to 20 carbon atoms and the alkynyl group having 2 to 20 carbon atoms of R¹ to R⁶ include a halogen atom such as a fluorine atom, a chlorine atom and a bromine atom; a hydroxyl group; a cyano group; and the like.

Examples of the substituent included in the cycloalkyl group having 3 to 20 carbon atoms and the aryl group having 6 to 20 carbon atoms of R¹ to R⁶ include a halogen atom such as a fluorine atom, a chlorine atom and a bromine atom; an alkyl group having 1 to 6 carbon atoms such as a methyl group and an ethyl group; an alkoxy group having 1 to 6 carbon atoms such as a methoxy group and an ethoxy group; a hydroxyl group; a cyano group; a nitro group; and the like.

In addition, the hydrocarbon groups of R¹ to R⁶ unsubstituted or having substituents may be groups in which an oxygen atom or a sulfur atom is intervened between the carbon-carbon bonds in the hydrocarbon group (i.e. it may be a group having an ether bond or a sulfide bond), except for a case that two or more oxygen atoms or sulfur atoms are catenated to be intervened.

Examples of the cation represented by the formula (I) include cations represented by e.g. the following formulas (I-a) to (I-e).

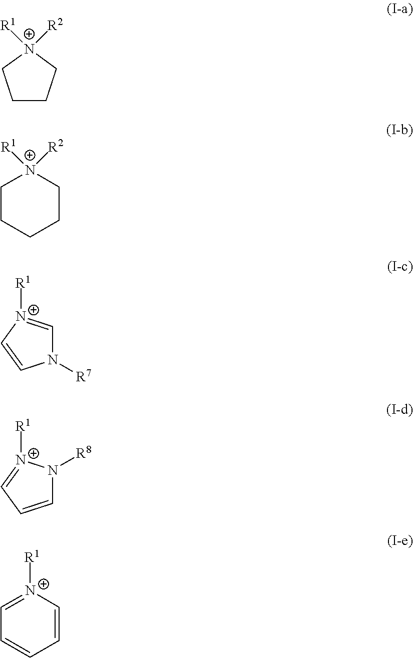

In the formula, R¹ and R² represent the same as described above. Each of R⁷ and R⁸ independently represents a hydrogen atom, or a hydrocarbon group having 1 to 20 carbon atoms which is unsubstituted or has substituents.

The number of carbon atoms in the hydrocarbon groups of R⁷ and R⁸ unsubstituted or having substituents is 1 to 20, preferably 1 to 10, and more preferably 1 to 5. In this case, when the hydrocarbon group has a substituent including carbon atoms, the number of carbon atoms in the hydrocarbon group does not include the number of carbon atoms in the substituent.

Examples of the hydrocarbon groups of R⁷ and R⁸ unsubstituted or having substituents include the same ones as listed as the hydrocarbon groups of R¹ to R⁶ unsubstituted or having substituents.

In the formulas (I-a) to (I-e), hydrogen atoms bound to carbon atoms constituting the ring may be substituted by a hydrocarbon group having 1 to 20 carbon atoms which is unsubstituted or has substituents; or a halogen atom such as a fluorine atom, a chlorine atom and a bromine atom.

The number of carbon atoms in the hydrocarbon group having 1 to 20 carbon atoms which is unsubstituted or has substituents is 1 to 20, preferably 1 to 10, and more preferably 1 to 5. In this case, when the hydrocarbon group has a substituent including carbon atoms, the number of carbon atoms in the hydrocarbon group does not include the number of carbon atoms in the substituent. Examples of the hydrocarbon group unsubstituted or having substituents include the same ones as listed as the hydrocarbon groups of R¹ to R⁶ unsubstituted or having substituents.

In addition, examples of the cation represented by the above-described formula (II) include the following (II-a), (II-b) and (II-c).

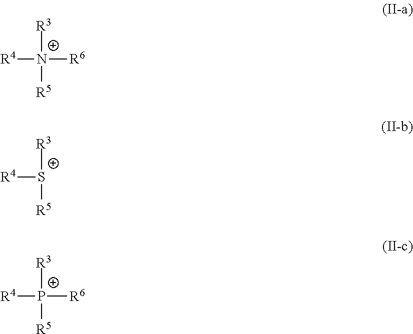

(wherein R³ to R⁶ represent the same as described above.)

Above all, the cation constituting the component (A) is preferably cations represented by the above formula (I) and the above formula (II-a), more preferably the cation represented by the above formula (I), and even more preferably a pyrrolidinium cation represented by the above formula (I-a), from the viewpoint that a secondary battery more excellent in cycling characteristics can be easily obtained.

Specific examples of the pyrrolidinium cation include, but are not limited to, 1,1-dimethylpyrrolidinium cation, 1-ethyl-1-methylpyrrolidinium cation, 1-methyl-1-n-propylpyrrolidinium cation, 1-methyl-1-n-butylpyrrolidinium cation, 1-methyl-1-n-pentylpyrrolidinium cation, 1-methyl-1-n-hexylpyrrolidinium cation, 1-methyl-1-n-heptylpyrrolidinium cation, 1-ethyl-1-n-propylpyrrolidinium cation, 1-ethyl-1-n-butylpyrrolidinium cation, 1-ethyl-1-n-pentylpyrrolidinium cation, 1-ethyl-1-n-hexylpyrrolidinium cation, 1-ethyl-1-n-heptylpyrrolidinium cation, 1,1-di-n-propylpyrrolidinium cation, 1-propyl-1-n-butylpyrrolidinium cation, 1,1-di-n-butylpyrrolidinium cation and the like.

The anion constituting the component (A) is not particularly limited. Examples of the anion include e.g. Cl⁻, Br⁺, I⁻, AlCl₄⁻, Al₂Cl₇⁻, BF₄⁻, B(CN)₄⁻, PF₆⁻, ClO₄⁻, NO₃⁻, AsF₆, SbF₆⁻, NbF₆⁻, TaF₆⁻, F(HF)ₙ⁻, CH₃COO⁻, CF₃COO⁻, C₃F₇COO⁻, CH₃SO₃⁻, CF₃SO₃⁻, C₄F₉SO₃⁻, (FSO₂)₂N⁻, (CF₃SO₂)₂N⁻, (CH₂FSO₂)₂N⁻, (C₂F₅SO₂)₂N⁻, (CF₃SO₂) (CF₃CO)N⁻, (CN)₂N⁻, (CF₃SO₂)₃C⁻, and the like.

Above all, as the anion constituting the component (A), the sulfonylamide anion having a fluorine atom is preferred. The sulfonylamide anion having a fluorine atom refers to an anion having a structure represented by —SO₂—N⁻— and a fluorine atom, and its examples include e.g. an anion represented by formula: R^{a}—SO₂—N⁻—SO₂—R^{b}, and an anion represented by formula: R^{c}—SO₂—N⁻—CO—R^{d}. In the formula, each of R^{a}, R^{b}, R^{c} and R^{d} independently represents a fluorine atom; an alkyl group having 1 to 5 carbon atoms such as a methyl group and an ethyl group; a fluoroalkyl group having 1 to 5 carbon atoms such as a fluoromethyl group, a difluoromethyl group, a trifluoromethyl group, a 2,2,2-trifluoroethyl group and a pentafluoroethyl group. At least one of R^{a} and R^{b}, and at least one of R^{c} and R^{d} are a fluorine atom or a fluoroalkyl group having 1 to 5 carbon atoms. Above all, (FSO₂)₂N-[bis(fluorosulfonyl)amide anion] is preferred as the anion constituting the component (A).

The component (A) is a combination of the cation and the anion.

The component (A) is preferably a compound including cations represented by the above formula (I) and the above formula (II-a) and a sulfonylamide anion having a fluorine atom, more preferably a compound including a cation represented by the above formula (I) and a sulfonylamide anion having a fluorine atom, even more preferably a compound including a pyrrolidinium cation and a sulfonylamide anion having a fluorine atom, and particularly preferably a compound including a pyrrolidinium cation and a bis(fluorosulfonyl)amide anion. When an electrolyte composition containing such compounds is used, a secondary battery more excellent in cycling characteristics can be easily obtained.

The component (A) can be used either alone or in combination of two or more kinds.

The content of the component (A) is preferably 40 to 99 mass %, and more preferably 50 to 90 mass % based on the total amount of the electrolyte compositions.

The method for producing the component (A) is not particularly limited, and a known method can be adopted such as a method for producing an ionic liquid.

### [Component (B)]

The component (B) constituting the electrolyte composition according to one embodiment of the invention is an ionic compound including a Group 1 or 2 metal ion in the periodic table.

In the electrolyte composition according to one embodiment of the invention, the component (B) is used as an ion source.

Examples of the metal ion constituting the component (B) include an alkali metal ion such as a lithium ion, a sodium ion and a potassium ion; a magnesium ion; and an alkaline earth metal ion such as a calcium ion and a strontium ion.

Examples of the anion constituting the component (B) include the same ones as described as the anion constituting the component (A).

The salt of the metal is preferably a lithium salt, a sodium salt, a potassium salt, a magnesium salt and a calcium salt, and more preferably the lithium salt.

Examples of the lithium salt include lithium bis(fluoromethanesulfonyl)amide(LiN(SO₂CH₂F)₂), lithium bis(trifluoromethanesulfonyl)amide(LiN(SO₂CF₃)₂), lithium bis(2,2,2-trifluoroethanesulfony)amide(LiN(SO₂C₂H₂F₃)₂), lithium bis(pentafluoroethanesulfonyl)amide(LiN(SO₂C₂F₅)₂), lithium bis(fluorosulfonyl)amide(LiN(SO₂F)₂), lithium tris(trifluoromethanesulfonyl)methide(LiC(SO₂CF₃)₃), lithium trifluoromethanesulfonate(LiCF₃SO₃), lithium hexafluorophosphate(LiPF₆), lithium tetrafluoroborate(LiBF₄), lithium tetracyanoborate(LiB(CN)₄), lithium bis-oxalate borate(LiB(C₂O₄)₂), lithium perchlorate (LiClO₄), lithium hexafluoroarsenate (LiAsF₆), and the like.

In the present invention, the salt of the Group 1 or 2 metal in the periodic table can be used either alone or in combination of two or more kinds.

The content of the component (B) is preferably 1 mass % or more, more preferably 5 mass % or more, and preferably 60 mass % or less, more preferably 50 mass % or less based on the total amount of the component (A), the component (B) and the component (C).

The content of the component (B) is preferably in a range of 1 to 60 mass %, and more preferably 5 to 50 mass % based on the total amount of the component (A), the component (B) and the component (C).

When the content of the component (B) is within the above range, an electrolyte composition having a sufficient ion conductivity can be easily obtained.

### [Component (C)]

The component (C) constituting the electrolyte composition according to one embodiment of the invention is a zwitterionic compound. The zwitterionic compound means a compound having a cationic portion and an anionic portion in one molecule.

The secondary battery using the electrolyte composition containing the component (C) is excellent in cycling characteristics even when the upper limit of the cutoff voltage during charging is increased to 4.4 V or higher.

The zwitterionic compound is not particularly limited, but the compound represented by the following formula (III) is preferred because of easy synthesis.

Y⁺—Z—SO₃⁻ (III)

In the formula (III), Y⁺ represents a cationic group including one or plural nitrogen atoms or phosphorus atoms and having one bonding hand, and Z represents an alkylene group having 2 to 5 carbon atoms which binds to the nitrogen atom or the phosphorus atom in Y⁺.

The number of carbon atoms in the cationic group represented by Y⁺ is preferably 1 to 40, more preferably 3 to 30, even more preferably 6 to 20, and particularly preferably 9 to 15.

Examples of the cationic group represented by Y⁺ include a group represented by any of the following formulas (IV) to (VIII).

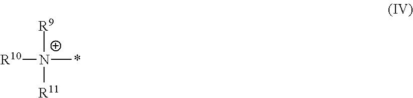

(In the formula, R⁹ represents an alkyl group having 1 to 10 carbon atoms with or without an ether bond, a cyanoalkyl group having 2 to 11 carbon atoms with or without an ether bond, an alkenyl group having 2 to 10 carbon atoms with or without an ether bond, or a substituted or unsubstituted aryl group having 6 to 20 carbon atoms. Each of R¹⁰ and R¹¹ independently represents a hydrogen atom, an alkyl group having 1 to 10 carbon atoms with or without an ether bond, a cyanoalkyl group having 2 to 11 carbon atoms with or without an ether bond, an alkenyl group having 2 to 10 carbon atoms with or without an ether bond, or a substituted or unsubstituted aryl group having 6 to 20 carbon atoms. In addition, R¹⁰ and R¹¹ may bind to each other to form a ring including a nitrogen atom. * represents a bonding hand.)

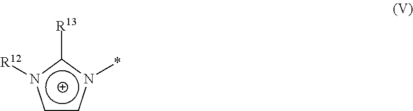

(In the formula, R¹² represents an alkyl group having 1 to 10 carbon atoms with or without an ether bond, a cyanoalkyl group having 2 to 11 carbon atoms with or without an ether bond, or an alkenyl group having 2 to 10 carbon atoms with or without an ether bond, and R¹³ represents a hydrogen atom or an alkyl group having 1 to 10 carbon atoms with or without an ether bond. * represents a bonding hand.)

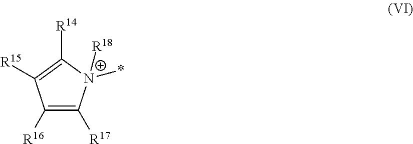

(In the formula, each of R¹⁴ to R¹⁸ independently represents a hydrogen atom or an alkyl group having 1 to 10 carbon atoms with or without an ether bond. * represents a bonding hand.)

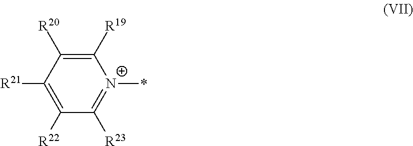

(In the formula, each of R¹⁹ to R²³ independently represents a hydrogen atom or an alkyl group having 1 to 10 carbon atoms with or without an ether bond. * represents a bonding hand.)

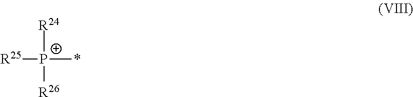

(In the formula, R²⁴ represents an alkyl group having 1 to 10 carbon atoms with or without an ether bond, a cyanoalkyl group having 2 to 11 carbon atoms with or without an ether bond, an alkenyl group having 2 to 10 carbon atoms with or without an ether bond, or a substituted or unsubstituted aryl group having 6 to 20 carbon atoms. Each of R²⁵ and R²⁶ independently represents a hydrogen atom, an alkyl group having 1 to 10 carbon atoms with or without an ether bond, a cyanoalkyl group having 2 to 11 carbon atoms with or without an ether bond, an alkenyl group having 2 to 10 carbon atoms with or without an ether bond, or a substituted or unsubstituted aryl group having 6 to 20 carbon atoms. * represents a bonding hand.)

In the formulas (IV) to (VIII), the number of carbon atoms in the alkyl groups of R⁹ to R²⁶ having 1 to 10 carbon atoms with or without an ether bond is preferably 1 to 8, and more preferably 1 to 5.

Examples of the alkyl group without an ether bond include a methyl group, an ethyl group, an n-propyl group, an n-butyl group, an n-pentyl group, an n-hexyl group and the like.

Examples of the alkyl group with an ether bond include groups represented by the following formulas, and the like.

R²⁷—O—Z¹—*

R²⁸—O—Z²—O—Z³—*

(In the formulas, R²⁷ represents an alkyl group having 1 to 8 carbon atoms, Z¹ represents an alkylene group having 2 to 9 carbon atoms, and a total number of carbon atoms in R²⁷ and Z¹ is 3 to 10. R²⁸ represents an alkyl group having 1 to 6 carbon atoms, Z² represents an alkylene group having 2 to 7 carbon atoms, Z³ represents an alkylene group having 2 to 7 carbon atoms, and a total number of carbon atoms in R²⁸, Z² and Z³ is 5 to 10. * represents a bonding hand.)

The number of carbon atoms in the cyanoalkyl groups of R⁹ to R¹² and R²⁴ to R²⁶ having 2 to 11 carbon atoms with or without an ether bond is preferably 2 to 9, and more preferably 2 to 6.

Examples of the cyanoalkyl group without an ether bond include a cyanomethyl group, a 2-cyanoethyl group, a 3-cyanopropyl group, a 4-cyanobutyl group, a 6-cyanohexyl group and the like.

Examples of the cyanoalkyl group with an ether bond include groups represented by the following formulas, and the like.

R²⁹—O—Z⁴—*

R³⁰—O—Z⁵—O—Z⁶—*

(In the formulas, R²⁹ represents a cyanoalkyl group having 2 to 9 carbon atoms, Z⁴ represents an alkylene group having 2 to 9 carbon atoms, and a total number of carbon atoms in R²⁹ and Z⁴ is 4 to 11. R³⁰ represents a cyanoalkyl group having 2 to 7 carbon atoms, Z⁵ represents an alkylene group having 2 to 7 carbon atoms, Z⁶ represents an alkylene group having 2 to 7 carbon atoms, and a total number of carbon atoms in R³⁰, Z⁵ and Z⁶ is 6 to 11. * represents a bonding hand.)

The number of carbon atoms in the alkenyl group of R⁹ to R¹² and R²⁴ to R²⁶ having 2 to 10 carbon atoms with or without an ether bond is preferably 2 to 9, and more preferably 2 to 6.

Examples of the alkenyl group without an ether bond include a vinyl group, an allyl group, a 1-butenyl group, a 2-butenyl group, a 1-pentenyl group and the like.

Examples of the alkenyl group with an ether bond include groups represented by the following formulas, and the like.

R²⁹—O—Z⁷—*

R³⁰—O—Z⁸—O—Z⁹—*

(In the formulas, R²⁹ represents an alkenyl group having 2 to 8 carbon atoms, Z⁷ represents an alkylene group having 2 to 8 carbon atoms, and a total number of carbon atoms in R²⁹ and Z⁷ is 4 to 10. R³⁰ represents an alkenyl group having 2 to 6 carbon atoms, Z⁸ represents an alkylene group having 2 to 6 carbon atoms, Z⁹ represents an alkylene group having 2 to 6 carbon atoms, and a total number of carbon atoms in R³⁰, Z⁸ and Z⁹ is 6 to 10. * represents a bonding hand.)

The number of carbon atoms in the substituted or unsubstituted aryl groups of R⁹ to R¹¹ and R²⁴ to R²⁶ having 6 to 20 carbon atoms is preferably 6 to 10.

Examples of the unsubstituted aryl group include a phenyl group, a 1-naphthyl group, a 2-naphthyl group and the like.

Examples of the substituent of the substituted aryl group include an alkyl group having 1 to 6 carbon atoms such as a methyl group and an ethyl group; an alkoxy group having 1 to 6 carbon atoms such as a methoxy group and an ethoxy group; a halogen atom such as a fluorine atom and a chlorine atom; and the like.

In addition, examples of the ring formed through the bond between R¹⁰ and R¹¹ and by including a nitrogen atom include a nitrogen-containing 5-membered ring such as a pyrrolidine ring; a nitrogen-containing 6-membered ring such as a piperazine ring, a piperidine ring and a morpholine ring; and the like.

In the formula (III), Z represents an alkylene group having 2 to 5 carbon atoms which binds to the nitrogen atom or the phosphorus atom of Y⁺.

Examples of the alkylene group of Z include a linear alkylene group such as an ethylene group, a trimethylene group, a tetramethylene group and a pentamethylene group; and a branched chain alkylene group such as a propane-1,2-diyl group, and a butane-1,3-diyl group.

The method for producing the zwitterionic compound used as the component (C) is not particularly limited. For example, as shown in the following formula, the zwitterionic compound (3) in which Y⁺ is a group represented by the above formula (IV) can be obtained by reacting the corresponding amine compound (1) with the sultone compound (2).

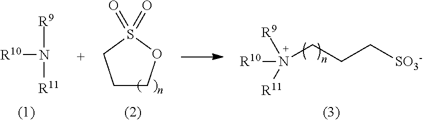

(In the formula, R⁹, R¹⁰ and R¹¹ represent the same as described above, and n represents 0, 1, 2 or 3.)

Examples of the amine compound (1) include trimethylamine, triethylamine, tri(n-butylamine) and the like.

These amine compounds can be produced and obtained by using the synthesis method described in Examples, and the like. Additionally, a commercially available product can also be used as the amine compound.

Examples of the sultone compound (2) include 1,2-ethane sultone, 1,3-propane sultone, 1,4-butane sultone, 2,4-butane sultone and 1,5-pentane sultone.

These are known compounds and can be produced and obtained by a known method. Additionally, a commercially available product can also be used as the sultone compound.

In the reaction between the amine compound (1) and the sultone compound (2), the sultone compound (2) is used in an amount of preferably 0.8 to 1.2 equivalents, and more preferably 0.9 to 1.1 equivalents based on the amine compound (1). When the sultone compound (2) is used in an amount within the above range, the step of removing unreacted substances can be omitted, or the time required for removal can be shortened.

The reaction between the amine compound (1) and the sultone compound (2) may be carried out in the absence of a solvent or in the presence of an inert solvent.

Examples of the inert solvent to be used include an ether-based solvent such as tetrahydrofuran and diglyme; a nitrile-based solvent such as acetonitrile and propionitrile; a ketone-based solvent such as acetone and methylethylketone; an aromatic hydrocarbon-based solvent such as toluene and xylene; a halogenated hydrocarbon-based solvent such as chloroform; and the like.

When an inert solvent is used, the amount to be used is not particularly limited, but it is normally used in an amount of preferably 100 parts by mass or less based on 1 part by mass of the amine compound (1).

The reaction temperature is not particularly limited, but is normally in a range of 0 to 200° C., preferably 10 to 100° C., and more preferably 20 to 60° C. In addition, the reaction may be carried out under a normal pressure condition or a pressurized condition.

The reaction time is not particularly limited, but is normally 12 to 332 hours, and preferably 24 to 168 hours.

The reaction is preferably carried out under an inert gas atmosphere from the viewpoint of preventing oxidation by oxygen and a reduced yield due to hydrolysis of the sultone compound (2) by moisture in the air.

Progress of the reaction can be confirmed by a normal analytical technique such as gas chromatography, high performance liquid chromatography, thin layer chromatography, NMR and IR.

After completion of the reaction, the resulting zwitterionic compound can be purified and isolated by a known purification method such as solvent washing, recrystallization and column chromatography.

Furthermore, the zwitterionic compound having a cationic group represented by the above formulas (V) to (VIII) can be individually produced by conducting the similar reaction by using the compounds represented by the following formulas (IX) to (XIV) instead of the amine compound (1).

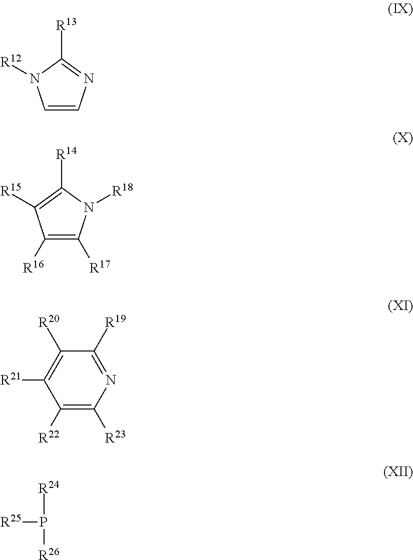

In the formulas (IX) to (XII), R¹² to R²⁶ represent the same as described above.

The compounds represented by the formulas (IX) to (XII) can be produced and obtained by using the synthesis method described in Examples, and the like. Additionally, a commercially available product can also be used.

The content of the component (C) is preferably 0.1 mass % or more, more preferably 1 mass % or more, and preferably 20 mass % or less, more preferably 15 mass % or less based on a total amount of the component (A), the component (B) and the component (C).

The content of the component (C) is preferably in a range of 0.1 to 20 mass %, and more preferably 1 to 15 mass % based on the total amount of the component (A), the component (B) and the component (C).

When the content of the component (C) is in the above range, an electrolyte composition having a sufficient ion conductivity can be easily obtained. In addition, the secondary battery containing the electrolyte composition is more excellent in cycling characteristics.

As described above, since the electrolyte composition according to one embodiment of the invention contains the component (A), it is excellent in flame retardance and non-volatility. In addition, as described below, since the electrolyte composition according to one embodiment of the invention contains the component (C), it is preferably used as an electrolytic material for a secondary battery excellent in cycling characteristics and having a high capacity.

### 2) Secondary Battery and Method for Using it

The secondary battery according to one embodiment of the invention has a positive electrode, a negative electrode and the electrolyte composition according to one embodiment of the invention.

The positive electrode normally includes a positive electrode collector and a positive electrode active substance layer.

The positive electrode collector holds the positive electrode active substance layer, and is responsible for transfer of electrons to and from the positive electrode active substance.

Materials constituting the positive electrode collector are not particularly limited. Examples of the materials include e.g. metal materials such as aluminum, nickel, iron, stainless steel, titanium and copper, and conductive polymers.

The positive electrode active substance layer is a layer formed on the surface of the positive electrode collector, in which the positive electrode active substance is included. Examples of the positive electrode active substance include inorganic active substances such as LiMn₂O₄, LiCoO₂, LiNiO₂, Li(Ni—Mn—Co)O₂ (e.g. LiNi_{1/3}Mn_{1/3}Co_{1/3}O₂), and a compound in which some of these transition metals are substituted by other elements.

The positive electrode active substance layer may contain an additive in addition to the positive electrode active substance.

Examples of these additives include a binder such as polyvinylidene fluoride, synthetic rubber-based binder and epoxy resin; a conductive aid such as carbon black, graphite and vapor-grown carbon fiber; an electrolytic salt such as the component (B) according to the present invention; an ion conductive polymer such as a polyethylene oxide (PEO)-based polymer, a polypropylene oxide (PPO)-based polymer, a polyethylene carbonate (PEC)-based polymer and a polypropylene carbonate (PPC)-based polymer; and the like.

The negative electrode normally includes a negative electrode collector and a negative electrode active substance layer. In addition, the negative electrode may be composed only of the negative electrode active substance layer (i.e. the negative electrode active substance layer serves also as the negative electrode collector).

The negative electrode collector holds the negative electrode active substance layer, and is responsible for transfer of electrons to and from the negative electrode active substance.

The materials constituting the negative electrode collector can be exemplified by the same materials as described as the materials for the positive electrode collector.

The negative electrode active substance layer is a layer formed on the surface of the negative electrode collector, in which a negative electrode active substance is included. Examples of the negative electrode active substance include a carbon material such as graphite, soft carbon and hard carbon; a lithium-transition metal composite oxide such as Li₄Ti₅O₁₂; a silicon material such as elemental silicon, silicon oxide and silicon alloy; a lithium metal; a lithium-metal alloy such as lithium-tin or lithium-silicon alloy; a simple substance, an alloy and a compound of a tin material and the like; a simple substance, an alloy and a compound of a Group 1 or 2 metal in the periodic table such as sodium, potassium, and magnesium; sulfur; or composite materials using these materials in combination; and the like.

The negative electrode active substance layer may contain an additive in addition to the negative electrode active substance. Examples of these additives can be exemplified by the same ones as described as the additive in the positive electrode active substance layer.

In the secondary battery according to one embodiment of the invention, the electrolyte composition according to one embodiment of the invention is present between the positive electrode and the negative electrode and is responsible for ionic conduction.

The secondary battery according to one embodiment of the invention may have a separator between the positive electrode and the negative electrode. The separator has a function of preventing short circuit by electronically insulating between the positive electrode and the negative electrode, to allow only movement of ion. Examples of materials constituting the separator include a porous body formed by an insulating plastic such as polyethylene, polypropylene and polyimide, and an inorganic fine particle such as silica gel.

The method for producing the secondary battery according to one embodiment of the invention is not particularly limited, and it can be manufactured in accordance with a known method.

The secondary battery according to one embodiment of the invention contains the electrolyte composition of the present invention. This electrolyte composition contains an ionic compound [component (A)] having a melting point of 200° C. or lower, and furthermore contains a zwitterionic compound [component (C)], and thus the discharge capacity of the secondary battery according to one embodiment of the invention rarely drops even when repeating charge and discharge with a high upper limit of a cutoff voltage during charging (e.g. 4.4 to 5.5 V).

When using the secondary battery of the present invention, the upper limit of the cutoff voltage during charging is preferably 4.4 to 5.5 V.

As described above, the secondary battery according to one embodiment of the invention is excellent in cycling characteristics even when the upper limit of the cutoff voltage during charging is increased, and it is a secondary battery having a higher capacity.

### EXAMPLES

The present invention will be further described below by way of Examples in detail. However, the present invention is not limited to the following Examples.

The units “parts” and “%” in each example refer to “parts by mass” and “mass %” respectively unless otherwise indicated.

### Production Example 1

5.30 g (41.7 mmol) of 1-n-butylpyrrolidine and 40 ml of acetone were put in a three-necked flask equipped with a dropping funnel, to which 5.09 g (41.7 mmol) of 1,3-propane sultone was slowly added at 25° C. while stirring the contents, and after completion of the addition, the whole content was stirred at the same temperature for 96 hours.

After completion of the reaction, the deposited white solid was taken by filtration and recrystallized by acetonitrile, and the resulting crystal was dried to obtain a zwitterionic compound (1) represented by the following formula. (yield: 9.82 g, yield rate: 94.5%)

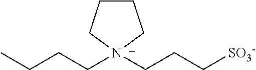

¹H-NMR spectrum data of the zwitterionic compound (1) are shown below.

¹H-NMR (CD₃OD, 500 MHz): δ=0.89-0.92 (t, J=7.5 Hz, 3H), 1.30-1.38 (sext, J=6.7 Hz, 2H), 1.65-1.71 (m, 214), 2.10-2.17 (m, 6H), 2.91-2.94 (t, J=7.5 Hz, 2H), 3.23-3.26 (m, 2H), 3.37-3.41 (m, 2H), 3.48-3.51 (t, J=1.8 Hz, 4H)

### Production Example 2

5.00 g (43.4 mmol) of N-(2-hydroxyethyl) pyrrolidine, 5 ml of 1,4-dioxane and 1.25 ml of 25% potassium hydroxide aqueous solution were put in a two-necked eggplant flask equipped with a dropping funnel, and the contents were stirred for 5 minutes. 2.53 g (47.8 mmol) of acrylonitrile was slowly added while continuing stirring, and stirring was continued at 25° C. for another 48 hours.

After completion of the reaction, 1,4-dioxane and unreacted acrylonitrile were distilled off from the reaction solution by using a rotary evaporator. The residue was dissolved in chloroform, the resulting chloroform solution was washed with purified water, the chloroform layer was dried with anhydrous magnesium sulfate, and then magnesium sulfate was filtered out. Chloroform was distilled off from the filtrate by using a rotary evaporator, and the residue was purified by alumina column chromatography [eluent: chloroform/methanol mixed solvent (50/1, vol/vol)] to obtain 5.46 g of N-(2-cyanoethoxy)ethyl] pyrrolidine as a colorless transparent liquid (yield rate: 75.3%).

5.44 g (32.3 mmol) of the resulting N-(2-cyanoethoxy)ethyl] pyrrolidine and 10 ml of acetone were put in a two-necked eggplant flask equipped with a dropping funnel under a nitrogen atmosphere, and 3.95 g (32.3 mmol) of 1,3-propane sultone was slowly added while stirring the contents at 25° C., and after completion of the addition, the stirring was continued at 25° C. for another 4 days.

After completion of the reaction, the deposited precipitate was taken by filtration, the resulting precipitate was washed with acetone, and then recrystallized with acetonitrile to obtain 6.93 g of 1-[2-(2-cyanoethoxy)ethyl]pyrrolidinium-1-(propylsulfonate) as a colorless crystal (yield rate: 73.9%).

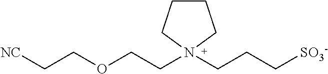

¹H-NMR spectrum data of the zwitterionic compound (2) are shown below.

¹H-NMR (CD₃OD, 500 MHz): δ=2.16-2.24 (m, 6H), 2.78-2.81 (t, J=7.5 Hz, 2H), 2.94-2.97 (t, J=7.5 Hz, 2H), 3.50-3.53 (m, 2H), 3.58-3.67 (m, 6H), 3.74-3.76 (t, J=5.9 Hz, 2H), 3.94-3.96 (m, 2H)

### Example 1

10.0 g of 1-methyl-1-propylpyrrolidinium bis(fluorosulfonyl)amide (manufactured by Kanto Chemical Co., Inc., melting point: −10° C.) and 0.919 g of lithium bis(trifluoromethylsulfonyl)amide (manufactured by Kishida Chemical Co., Ltd.) were mixed in a glove box.

The zwitterionic compound (1) obtained in Production Example 1 was added to the resulting mixture (A) so that the concentration of the zwitterionic compound (1) was 1% based on the whole composition, and stirred at 60° C. to obtain an electrolyte composition (1).

### Example 2

An electrolyte composition (2) was obtained in the same manner as Example 1 except that the addition amount of the zwitterionic compound (1) was changed so that the concentration of the zwitterionic compound (1) was 2% in Example 1.

### Example 3

An electrolyte composition (3) was obtained in the same manner as Example 1 except that the addition amount of the zwitterionic compound (1) was changed so that the concentration of the zwitterionic compound (1) was 3% in Example 1.

### Example 4

An electrolyte composition (4) was obtained in the same manner as Example 1 except that the addition amount of the zwitterionic compound (1) was changed so that the concentration of the zwitterionic compound (1) was 5% in Example 1.

### Example 5

An electrolyte composition (5) was obtained in the same manner as Example 4 except that the zwitterionic compound (2) was used instead of the zwitterionic compound (1) in Example 4.

### Comparative Example 1

A mixture (A) of N-methyl-N-propylpyrrolidinium bis(fluorosulfonyl) amide and lithium bis(trifluoromethylsulfonyl) amide in Example 1 was used as the electrolyte composition (6).

### (Constant Current Charge/Discharge Test 1)

31.9 g of lithium cobaltite (manufactured by Kusaka rare metal products Co., Ltd.) and 2.25 g of acetylene black (Denka Black, manufactured by Denka Company Limited) were mixed while grinding them in a mortar, to which subsequently 27.5 g of PVDF (polyvinylidene fluoride) solution (KF Polymer #1120, solid content: 12%, manufactured by Kureha Battery Materials Japan Co. Ltd.) and 54 g of N-methylpyrrolidone (manufactured by Wako Pure Chemical Industries, Ltd.) were added and mixed. The resulting mixture was stirred by using a homogenizer for 30 minutes to obtain a positive electrode active substance dispersion.

The resulting positive electrode active substance dispersion was applied on an aluminum foil by using an applicator, and the resulting coating film was dried at 80° C. for 1 hour. This product was pressed at 70° C. and 2 MPa for 1 hour to produce an electrode sheet (1).

Subsequently, a charge/discharge test was carried out under the following conditions by using a module-type Potentiostat/Galvanostat (VMP-300, manufactured by Bio-Logic Science Instruments SAS).

Measurement temperature: 40° C.
Cutoff voltage: 3.0 to 4.6 V
Positive electrode: lithium cobaltite electrode (electrode sheet (1) described above)
Negative electrode: lithium foil
Separator: glass filter (GA-55, manufactured by ADVANTEC Co., LTD.)
Current density: 396 μA/cm²

Note that the electrolyte compositions (1) to (4) and (6) were individually impregnated into the glass filter used as a separator.

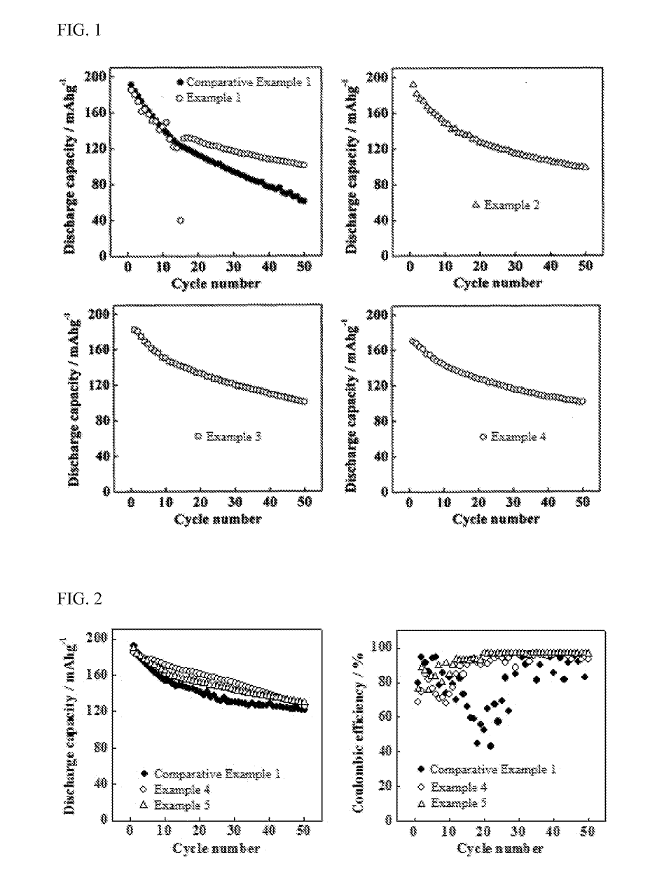

The obtained results are shown in FIG. 1. In FIG. 1, the abscissa represents the number of charge and discharge, and the ordinate represents discharge capacity.

### (Constant Current Charge/Discharge Test 2)

31.9 g of LiNi_{1/3}Mn_{1/3}Co_{1/3}O₂ (NMC) (manufactured by Kusaka rare metal products Co., Ltd.) and 2.25 g of acetylene black (Denka Black, manufactured by Denka Company Limited) were mixed while grinding them in a mortar, to which subsequently 27.5 g of PVDF (polyvinylidene fluoride) solution (KF Polymer #1120, solid content: 12%, manufactured by Kureha Battery Materials Japan Co. Ltd.) and 54 g of N-methylpyrrolidone (manufactured by Wako Pure Chemical Industries, Ltd.) were added and mixed. The resulting mixture was stirred by using a homogenizer for 30 minutes to obtain a positive electrode active substance dispersion.

The resulting positive electrode active substance dispersion was applied on an aluminum foil by using an applicator, and the resulting coating film was dried at 80° C. for 1 hour. This product was pressed at 70° C. and 2 MPa for 1 hour to produce an electrode sheet (2).

Subsequently, a charge/discharge test was carried out under the following conditions by using a module-type Potentiostat/Galvanostat (VMP-300, manufactured by Bio-Logic Science Instruments SAS).

Measurement temperature: 40° C.
Cutoff voltage: 3.0 to 4.8 V
Positive electrode: NMC electrode (electrode sheet (2) described above)
Negative electrode: lithium foil
Separator: glass filter (GA-55, manufactured by ADVANTEC Co., LTD.)
Current density: 396 μA/cm²

Note that the electrolyte compositions (4) to (6) were individually impregnated into the glass filter used as a separator.

The obtained results are shown in FIG. 2. In FIG. 2 (left), the abscissa represents the number of charge and discharge, and the ordinate represents discharge capacity. Further, in FIG. 2 (right), the abscissa represents the number of charge and discharge, and the ordinate represents coulombic efficiency (discharge capacity/charge capacity).

The followings can be seen from FIGS. 1 and 2.

Compared to Comparative Example 1, Examples 1 to 5 show that decrease in discharge capacity is suppressed when charge and discharge are repeated. Thus, in the secondary battery using the electrolyte composition according to one embodiment of the invention, the discharge capacity drops more rarely, even when repeating charge and discharge with a high upper limit of the cutoff voltage during charging.

1-9. (canceled)

10. A method for using a secondary battery, the secondary battery comprising:
an electrolyte composition including a following component (A), component (B) and component (C);
a positive electrode; and
a negative electrode,
wherein
a content of the component (B) is 1 to 60 mass % based on a total amount of the component (A), the component (B) and the component (C);
a content of the component (C) is 0.1 to 20 mass % based on the total amount of the component (A), the component (B) and the component (C); and
an upper limit of a cutoff voltage during charging is 4.4 to 5.5 V:
component (A): an ionic compound having a melting point of 200° C. or lower (except for the following components (B) and (C)),
component (B): an ionic compound including a Group 1 or 2 metal ion in the periodic table,
component (C): a zwitterionic compound.

11. The method for using the secondary battery according to claim 10, wherein the component (A) is a compound including a pyrrolidinium cation.

12. The method for using the secondary battery according to claim 10, wherein the component (A) is a compound including a sulfonylamide anion having a fluorine atom.

13. The method for using the secondary battery according to claim 10, wherein the component (B) is a compound including a lithium ion.

14. The method for using the secondary battery according to claim 10, wherein the component (C) is a compound represented by the following formula (III):
Y⁺—Z—SO₃⁻ (III)
wherein Y⁺ represents a cationic group including one or plural nitrogen atoms or phosphorus atoms and having one bonding hand, and Z represents an alkylene group having 2 to 5 carbon atoms which binds to the nitrogen atom or the phosphorus atom in Y⁺.

15. An electrolyte composition comprising the following component (A), component (B) and component (C1):
component (A): an ionic compound having a melting point of 200° C. or lower (except for the following components (B) and (C1)),
component (B): an ionic compound including a Group 1 or 2 metal ion in the periodic table,
component (C1): a zwitterionic compound represented by the following formula (III):
Y⁺—Z—SO₃⁻ (III)
wherein Y⁺ represents a cationic group including one or plural nitrogen atoms or phosphorus atoms and having one bonding hand, and Z represents an alkylene group having 2 to 5 carbon atoms which binds to the nitrogen atom or the phosphorus atom in Y⁺, Y⁺ represents a cationic group represented by the following formula (IV): 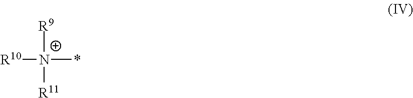
wherein R⁹ represents a cyanoalkyl group having 2 to 11 carbon atoms with an ether bond, each of R¹⁰ and R¹¹ independently represents a hydrogen atom, an alkyl group having 1 to 10 carbon atoms with or without an ether bond, a cyanoalkyl group having 2 to 11 carbon atoms with or without an ether bond, an alkenyl group having 2 to 10 carbon atoms with or without an ether bond, or a substituted or unsubstituted aryl group having 6 to 20 carbon atoms, R¹⁰ and R¹¹ may bind to each other to form a ring including a nitrogen atom. * represents a bonding hand.

16. The electrolyte composition according to claim 15, wherein the component (A) is a compound including a pyrrolidinium cation.

17. The electrolyte composition according to claim 15, wherein the component (A) is a compound including a sulfonylamide anion having a fluorine atom.

18. The electrolyte composition according to claim 15, wherein the component (B) is a compound including a lithium ion.

19. A secondary battery having a positive electrode, a negative electrode, and the electrolyte composition according to claim 15.

20. The secondary battery according to claim 19, wherein an upper limit of a cutoff voltage during charging is 4.4 to 5.5 V.
